(19) United States
(12) Patent Application Publication
(10) Pub. No.: US 2025/0307554 A1
(43) Pub. Date: Oct. 2, 2025

(54) METHODS FOR IMPROVING LISTWISE RANKING IN LARGE LANGUAGE MODELS

(71) Applicant: Comcast Cable Communications, LLC, Philadelphia, PA (US)

(72) Inventors: Raphael Tang, Washington, DC (US); Ferhan Ture, Washington, DC (US)

(21) Appl. No.: 18/665,978

(22) Filed: May 16, 2024

Related U.S. Application Data
(60) Provisional application No. 63/570,913, filed on Mar. 28, 2024.

(51) Int. Cl. G06F 40/289

(52) U.S. Cl. CPC G06F 40/289

(57) ABSTRACT

Systems, apparatuses, and methods are described for minimizing prompt order bias in a large language model (LLM). Using an original input prompt for an LLM, that may include instructions and ordered list, a plurality of different LLM input prompts may be generated. A plurality of LLM outputs may be determined, for example, by providing the plurality of LLM input prompts comprising the original instructions but with the order of the list permutated. A positional bias of the LLM may appear differently in the plurality of LLM outputs, for example, based on the differing list orders of the plurality of LLMs. A final LLM output may be generated, for example, by aggregating the LLM outputs to minimize the effects of positional bias.

### CROSS-REFERENCE TO RELATED APPLICATIONS

This application claims the benefit of U.S. Provisional Application No. 63/570,913, filed Mar. 28, 2024. The above-referenced application is hereby incorporated by reference in its entirety.

### BACKGROUND

Large language models (LLMs) may recognize, summarize, translate, predict, and generate an order of text or other content. The LLM output, however, may depend on positional factors such as prompt order and input length. LLMs may exhibit positional bias and become “lost in the middle,” for example, in using words and phrased in a context window and complicating listwise rankings as a result.

### SUMMARY

The following summary presents a simplified summary of certain features. The summary is not an extensive overview and is not intended to identify key or critical elements.

Systems, apparatuses, and methods are described for determining a list wise ranking of a large language model (LLM) using permutation self-consistency to overcome positional bias. An original input prompt, including a list of items having a particular order and instructions to sort the list may be received, for example, for an LLM. Using the original input prompt, for example, a series of additional LLM input prompts for the LLM may be generated that may comprise the same instructions but comprise the list of items in a different, permuted order. A series of different LLM outputs may be generated from the series of additional LLM input prompts, for example, by randomly permuting the order of the list. Each permuted LLM input prompt may experience any positional bias differently because each permuted list may provide the list in a different order. A final LLM output may be determined and the prompt order bias minimized, for example, by aggregating all the LLM outputs and comparing the resulting output list orders for similarity.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A and 3B show examples of large language model (LLM) inputs comprising instructions to sort a list of objects and the list of objects, and associated outputs.

FIGS. 4A and 4B show examples of an LLM instructed to order a list of number inputs and associated outputs.

FIG. 5 shows an example of determining a final LLM output by aggregating a plurality of LLM outputs using the same instructions but using a permutation of an LLM input.

FIG. 6 shows example LLM outputs of a plurality of LLM inputs using permutations of an LLM input and inversion operations used to move between the LLM outputs.

FIGS. 7 and 8 are example flow charts showing example methods for determining a most similar LLM output.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

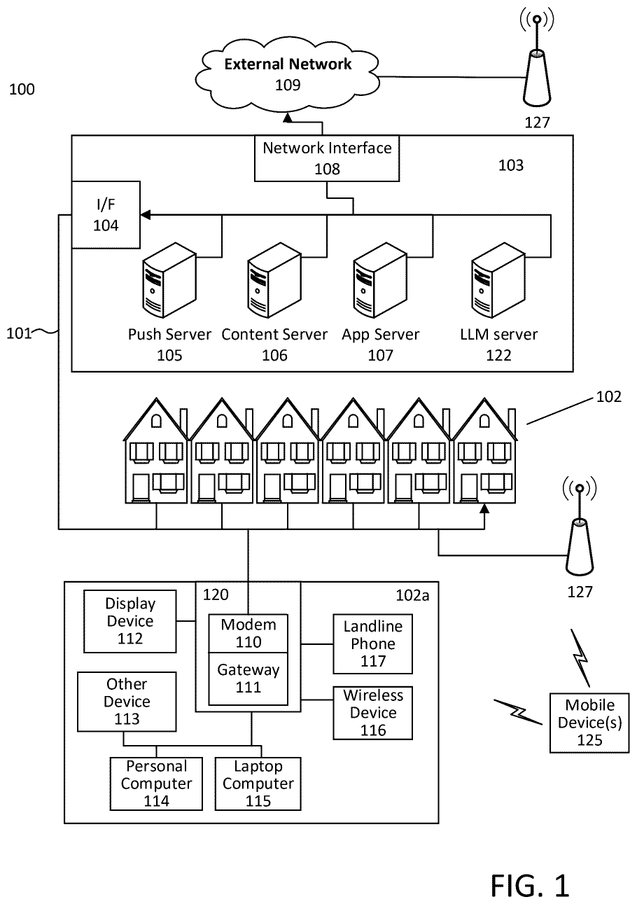

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122 (e.g., a large language model (LLM) server), and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the LLM server 122 comprising one or more LLM models, additional push, content, and/or application servers, and/or other types of servers. Although shown separately, the push server 105, the content server 106, the application server 107, the LLM server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

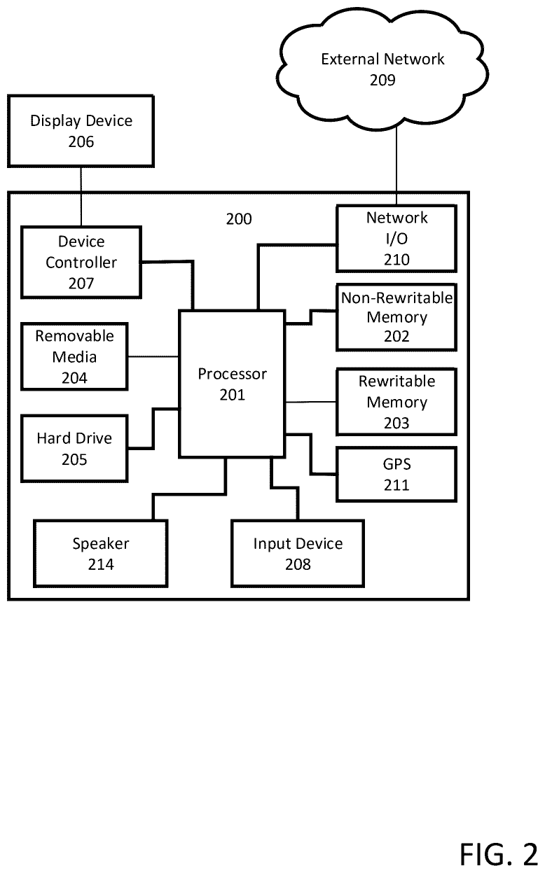

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a content server 106, an LLM server 122, a mobile device 125, a wireless device 116, a personal computer 114, a laptop computer 115, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

Large language models (LLMs) may include machine learning models that may generate text and/or data using large amounts of data. LLMs may read, write, code, improve productivity, etc. Current LLMs include, for example, open families of LLaMA v2 models, Mistral-7B Instruct, and Zephyr_{β}-7B, along with the closed GPT-3.5 (Turbo, the “0613” version) and GPT-4 from OpenAI. LLMs together with artificial intelligence (AI) and machine learning may be used to analyze, respond to, and/or create language and text. LLMs may, for example, generate text and ideas, for example, that mimics those of humans. LLMs may improve the quality of search results. LLMs may generate content, for example, based on prompts provided by a user. The content may comprise dialogue generation, for example, as used in chatbots and/or virtual assistants. The content may be text to speech (TTS), for example, to translate between different languages. LLMs may be used to anticipate the next word in a phrase and/or review documents. LLMs may be used to extract and sort data from large data sets.

LLMs may respond cogently to free-form textual prompts. LLMs may be used with a chatbot, for example, to simulate a conversation with a user. The textual prompts may passed to the LLM using an input prompt. The maximum number of tokens an LLM model may consider, for example, is determined by a context window in an LLM model. Context in LLMs may involve understanding words and/or phrases, for example, based on surrounding text. Context lengths for some LLMs may be more than several thousand tokens, for example, where a token may be measured as a number of characters (e.g., four characters). LLMs may exhibit positional bias in how they use context, and the quality of LLM responses may vary with nuisance position factors (e.g., prompt order and input length) which may affect a listwise ranking. an LLM may produce conflicting output results, for example, based on swapping the order of input prompts. A LLM server 122 may comprise the LLM.

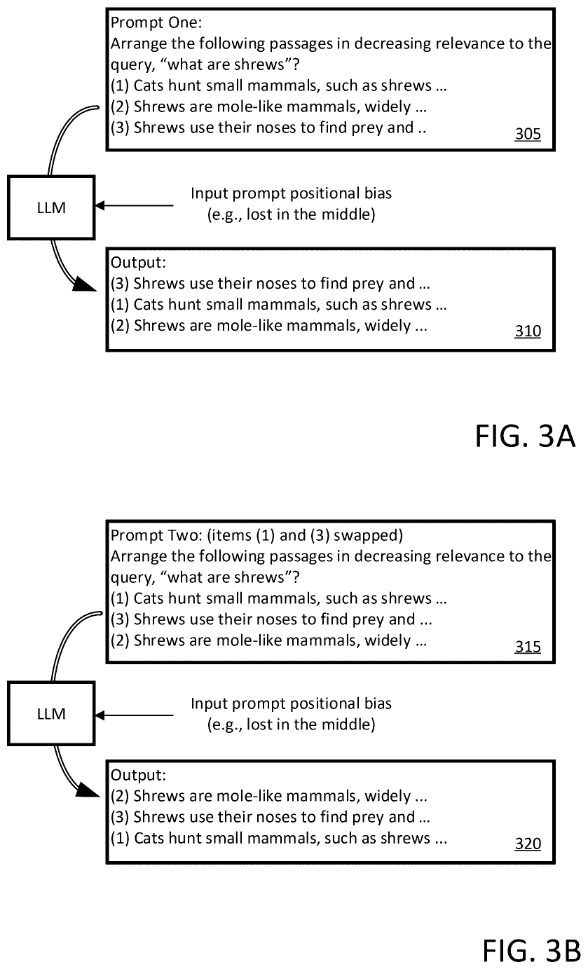

FIGS. 3A and 3B show examples of large language model (LLM) inputs comprising instructions to sort a list of objects and the list of objects, and associated outputs. Specifically, FIGS. 3A and 3B show two different LLM inputs 305 and 315 comprising the same instructions (e.g., arrange passages in decreasing relevance to the query, “what are shrews”?) and input prompts, but with different ordering of the input parameters, and the corresponding LLM output 310 and 320 demonstrating a positional bias of the output. Several positional biases may interfere with the model, for example, if the correct output order, from most relevant to least, is (2, 3, 1). LLMs may get “lost in the middle” of an input prompt. The LLM may get lost in the middle of a long context (e.g., up to several thousand words), for example, and use the middle portion poorly and mis-rank middle passages (e.g., phrases, words, numbers, objects, etc.). FIGS. 3A and 3B show examples where the middle input prompt is missorted to the end, but the position of the mis-sort may occur randomly. Rather than the output 320 being ranked (2, 3, 1), for example, the output may have ranked the input prompts as (2, 1, 3).

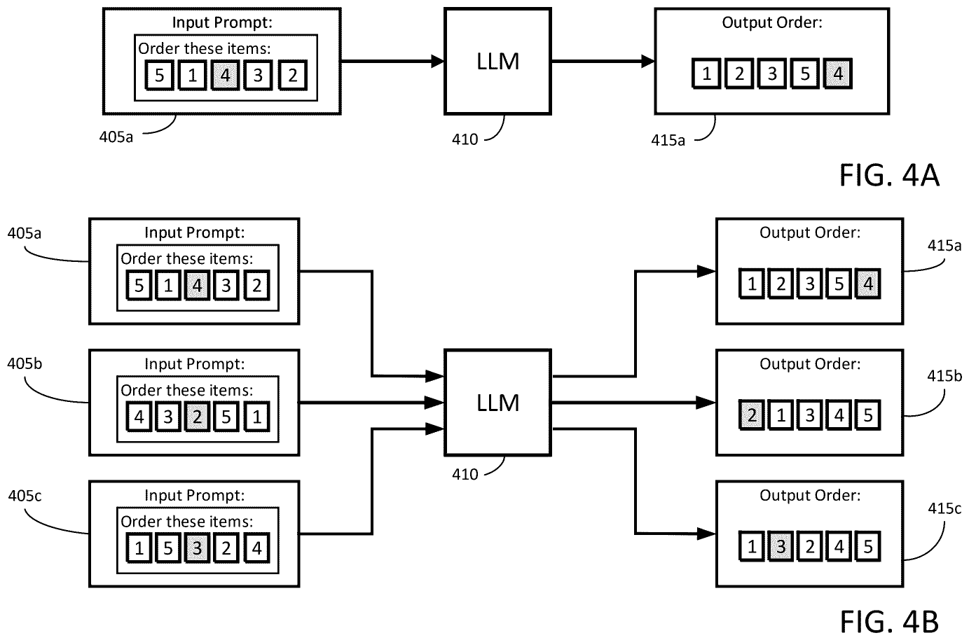

FIGS. 4A and 4B show examples of an LLM instructed to order a list of number inputs and associated outputs demonstrating positional bias of the number inputs. Specifically, FIG. 4A shows an example of an input prompt 405a comprising instructions (e.g., order these items) and a list of items (e.g., (5, 1, 4, 3, 2)) being provided to an LLM 410, and the LLM 410 producing an output 415a (e.g., (1, 2, 3, 5, 4)). FIG. 4B shows an example of a plurality of input prompts 405a, 405b, and 405c (generally, input prompts 405) comprising the same instructions but with the list of items listed differently (e.g., ordered differently). The output orders 415a, 415b, and 415c (generally, output order(s) 415) demonstrate a prompt order bias (e.g., lost in the middle). The prompt order bias may causes a middle item of the lists included in the input prompts 405a, 405b, and 405c to the LLM 410 be ordered incorrectly. The output orders 415a, 415b, and 415c also demonstrate that the missorted positions of the missorted items may occur at different positions in the sort.

The plurality of input prompts 405a, 405b, and 405c, comprising instructions and a list of items for an LLM 410, may be generated from the original input prompt 405a. The input prompts 405 may all comprise, for example, the same instructions (e.g., order these items) and list of items included as part of original input prompt 405a, but order the list of items (e.g., a list of numbers) in each prompt differently. The plurality of input prompts 405a, 405b, and 405c may be generated, for example, by parsing the input prompt 405a and keeping the instructions consistent between the plurality of input prompts but permuting the order of the original list of items. The plurality of input prompts 405a, 405b, and 405c to the LLM 410 may result in different LLM outputs 415a, 415b, and 415c, for example, based on a positional bias (e.g., lost in the middle) of the LLM 410.

Different LLM outputs to an original LLM input prompt may be used to generate a likely LLM output response for a user. Different LLM outputs, each showing an inherent positional bias of the LLM, may be used, for example, to generate a likely LLM output response that overcomes the inherent positional bias of the LLM. Multiple different orders of a list of items may be generated, for example, from an ordered list included in the original LLM input prompt. The multiple different orders may be generated, for example, by rearranging the items in a list in different orders (e.g., by permuting the order of the list).

A permutation (e.g., a reordering) may comprise, for example, swapping (e.g., switching) the placement of multiple pairs of items in the list. Swapping the first and third elements of a list {1, 2, 3, 4, 5}, for example, results in {2, 1, 3, 4, 5}. A permutation may also comprise, for example, a cycling of three or more members of the list; when cycling members of a list (or sub-list), the members at the ends of the list are cycled to the other end of the list (or sub-list). Cycling of the first three elements of the list {1, 2, 3, 4, 5} to the right, for example, results in {3, 1, 2, 4, 5}. Cycling of the first three elements of the list {1, 2, 3, 4, 5} one place to the left, for example, results in {2, 3, 1, 4, 5}. Importantly, however, a cycle may be written as a series of swaps (e.g., switches). The ordered list {1, 2, 3, 4, 5} may be reordered (e.g., permuted) as {3, 2, 1, 4, 5}, for example, by cycling the first three elements of {1, 2, 3, 4, 5} or by first swapping the first and second element, resulting in {2, 1, 3, 4, 5}, and subsequently swapping the first and third to achieve {3, 2, 1, 4, 5}. Moreover, the direction of the cycle described above may be reversed to be one place to the right, for example, by changing the order of the swap operations.

A permutation may comprise, for example, one or more pair swaps and/or one or more cycles. Permutations of the ordered list {5, 1, 4, 3, 2} (e.g., the ordered list 405a of FIG. 4A) may comprise, for example, {4, 3, 2, 5, 1} (e.g., the ordered list 405b of FIG. 4B) and {1, 5, 3, 2, 4} (e.g., the ordered list 405c of FIB. 4B). The ordered list {4, 3, 2, 5, 1} may be shown to be a permutation of the ordered list {5, 1, 4, 3, 2}, for example, by cycling all members of the list two steps to the left or three steps to the right and swapping the positions of 5 and 1. The ordered list {1, 5, 3, 2, 4} may be shown to be a permutation of the ordered list {5, 1, 4, 3, 2}, for example, by swapping the position of 5 and 1 and cycling the sub-list {4, 3, 2} one step to the left or two steps to the right.

The inner workings of an LLM may not be known, for example, so the LLM is sometimes considered a “black box,” where the decisions and determinations used to generated an output are unknown. An original LLM input may comprise instructions to sort a list and the list in an original order. Using only the original LLM input, the generated LLM output may show an underlying positional bias of the LLM that may not be understood. The underlying black box nature and positional biases of LLMs, however, may be overcome.

This positional bias may be overcome, for example, by comparing outputs of multiple LLM inputs that use the same list of items, but where each is ordered differently. The list may be reordered a plurality of times to generate a plurality of different list orders (e.g., permutations) of the list. A plurality of different LLM input prompts may be generated, for example, where each of the plurality of different LLM input prompts comprise the same instructions as the original LLM input prompt (e.g., to sort the list) but with the list in one of the plurality of different list orders. An LLM output may be generated, for example, for each of the plurality of different LLM input prompts.

Each of the LLM outputs may experience the same underlying positional bias, for example, but each of the LLM outputs will show the positional bias in a different way. An LLM tasked to order the list {5, 1, 4, 3, 2} (e.g., 405a of FIG. 4B), may order the list as {1, 2, 3, 5, 4} (e.g., 415a of FIG. 4B). The LLM output {1, 2, 3, 5, 4} shows a positional bias where the middle item of the input list is misordered. Multiple additional orderings of the list {5, 1, 4, 3, 2} may be generated, for example, by using different LLM inputs with the list in different orders. The LLM output may order the list as {2, 1, 3, 4, 5} (e.g. 415b of FIG. 4A), for example, if the list is input as {4, 3, 2, 5, 1} (e.g., 405b of FIG. 4B) which comprises the same items, but ordered differently. Similarly, the LLM output may order the list as {1, 3, 2, 4, 5} (e.g., 415c of FIG. 4B), for example, if the list is input as {1, 5, 3, 2, 4} (e.g., 405c of FIG. 4A). Each of these outputs may show the same underlying position bias, for example, but by changing the input ordering of the list the bias misorders different members of the list.

The likely ordering of an original LLM input may be determined, for example, by distilling a plurality of LLM outputs, from a plurality of LLM inputs, into an ordering that is not biased by the initial ordering. Correlations between and/or among the LLM outputs may be determined. In FIG. 4A, for example, the plurality of output orders 415 using the plurality of different orderings of the input prompts 405, show that the most likely first position is 1, the most likely third position is 3, the most likely fourth position is 4, and the most likely fifth position is 5, where most likely is the position the numeral is ordered most often. Moreover, final positions of a likely ordering of an original LLM input may be determined by other context of the plurality of LLM outputs. In FIG. 4B, for example, the position of 2 may be determined by elimination where the other numerals in the list {5, 1, 4, 3, 2} have been sorted as described above.

Additionally, or alternatively, a plurality of LLM outputs may be compared based on how the plurality of LLM outputs may be reordered to match other LLM outputs of the plurality of LLM outputs. LLM outputs may correlated and/or compared, for example, based on a number of operations (e.g., swaps and/or cycles) that are made for different LLM outputs to match. In FIG. 4B output order 415b may match output order 415a with two operations, for example, by swapping the first and second positions and the fourth and fifth positions. Similarly, in FIG. 4B output order 415c may match output order 415a with two operations, for example, by swapping the second and third positions and the fourth and fifth positions.

Additionally, or alternatively, a plurality of LLM outputs may be compared based on orderings that LLM outputs may pass through during operations (e.g., the similarity of the orderings that may be reached). An ordering that many LLM outputs pass through in reordering to match other LLM outputs may be more similar and may be considered more likely. The LLM output {1, 2, 3, 4, 5} may be reached by each of the output orders 415, for example, by performing a single swap of a pair of list members—the fourth and fifth members for output order 415a, the first and second members for 415b, and the second and third members for 415c-indicating that the LLM output {1, 2, 3, 4, 5} may be more likely.

Permutation self-consistency may improve the quality, consistency, and prompt-order invariance of a black-box LLM. A set of input prompts, with randomly permuted input lists, may be used as inputs to an LLM, for example, to generate a set of output rankings. The set of outputs may be aggregated to generate a likely (e.g., final, central, etc.) order that minimizes a determined distance between the members of the set of outputs to marginalize prompt order as a factor. The likely (e.g., final, central, etc.) ranking may be, for example, the possible ordering that is closest to most members of the set of output rankings. The likely (e.g., final, central, etc.) ranking described in FIGS. 4A and 4B may be determined to be {1, 2, 3, 4, 5}, for example, because it is the ordering that may be reached by any member of the output orders 415 using the fewest number of operations. The number of operations necessary to move between output orderings may be characterized as a “distance” between the output orderings.

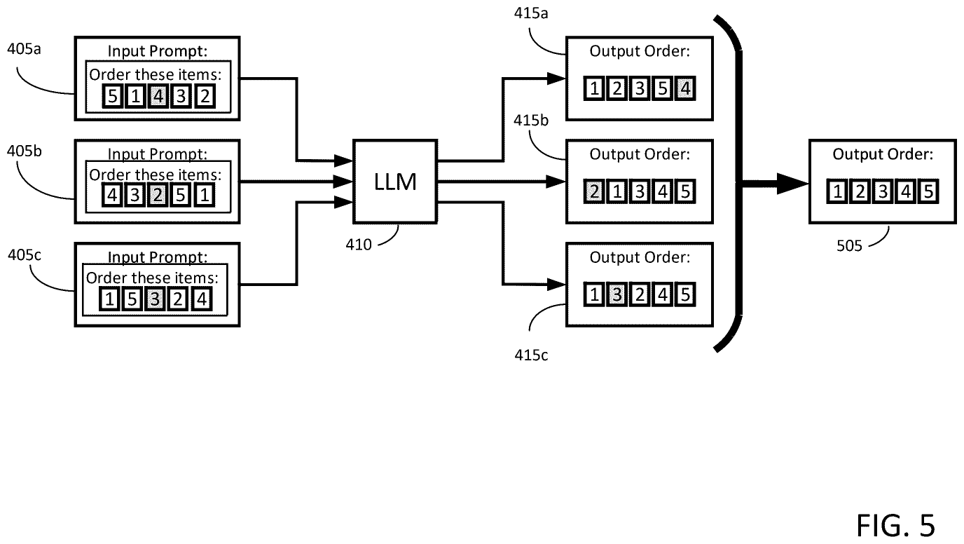

An LLM outputs may be aggregated into a final (e.g., central, likely, etc.) ranking that minimizes a distance between the LLM outputs. FIG. 5 shows an example of determining a final (e.g., central, likely, etc.) LLM output by aggregating a plurality of LLM outputs using the same instructions but using a permutation of an LLM input. Specifically, FIG. 5 shows an example of generating a plurality of LLM input prompts 405a, 405b, and 405c for an LLM 410, the associated LLM outputs 415a, 415b, and 415c, of the LLM inputs 405a, 405b, and 405c, from the LLM 410, and a final (e.g., central, likely, etc.) LLM output 505 determined using the LLM outputs 415a, 415b, and 415c.

A final (e.g., central, likely, etc.) LLM output 505 may be determined by aggregating a set of LLM outputs 415. To aggregate a set of LLM outputs the LLM outputs may be analyzed for their similarity. LLM outputs may be considered more likely, for example, if they are more similar to a greater number of LLM outputs. The final LLM output may be determined, for example, based on the similarity of the LLM outputs and/or potential LLM outputs that may be reached using the fewest permutation operations. An n-ranking may be defined as a permutation:

$$σ : \{ 1 , … , n \} \to \{ 1 , … , n \} \qquad ( 1 )$$

of a sequence. For some sequence X, for example,

$$X := {\{ {X}_{i} \}}_{i = 1}^{n} , \qquad ( 2 )$$

define X [σ] as the permuted sequence of X transformed by σ, where

$${X [ σ ]}_{i} := {X}_{σ ( i )} . \qquad ( 3 )$$

An inversion vector of σ, may be defined as

$${inv ( σ )}_{i} := \# \{ j : σ ( j ) > σ ( i ) , j < i ) \} . \qquad ( 4 )$$

A similarity may be quantified using inversion vectors. A similarity may be quantified, for example, using the Kendall tau distance. The Kendall tau distance between two rankings σ₁ and σ₂ may be defined as the number of inversions in σ₁⁻¹ o σ₂:

$${d}_{k} ( {σ}_{1} , {σ}_{2} ) := {\sum }_{i = 1}^{n} {inv ( {σ}_{1}^{- 1} ∘ {σ}_{2} )}_{i} . \qquad ( 5 )$$

The Kendall tau distance may be thought of as the number of pairwise disagreements (e.g., the discordant pairs) in the permutation ordering. The distance may comprise one affine transform away from the Kendall tau correlation, for example, used to measure list order similarity, where the Kendall tau correlation is defined as:

$$τ ( {σ}_{1} , {σ}_{2} ) := 1 - \frac{2 {d}_{k} ( {σ}_{1} , {σ}_{2} )}{( \begin{matrix}n \\ 2\end{matrix} )} . \qquad ( 6 )$$

The range of τ is from τ=1, if σ1=σ2, to τ=−1, if one is the other's reverse.

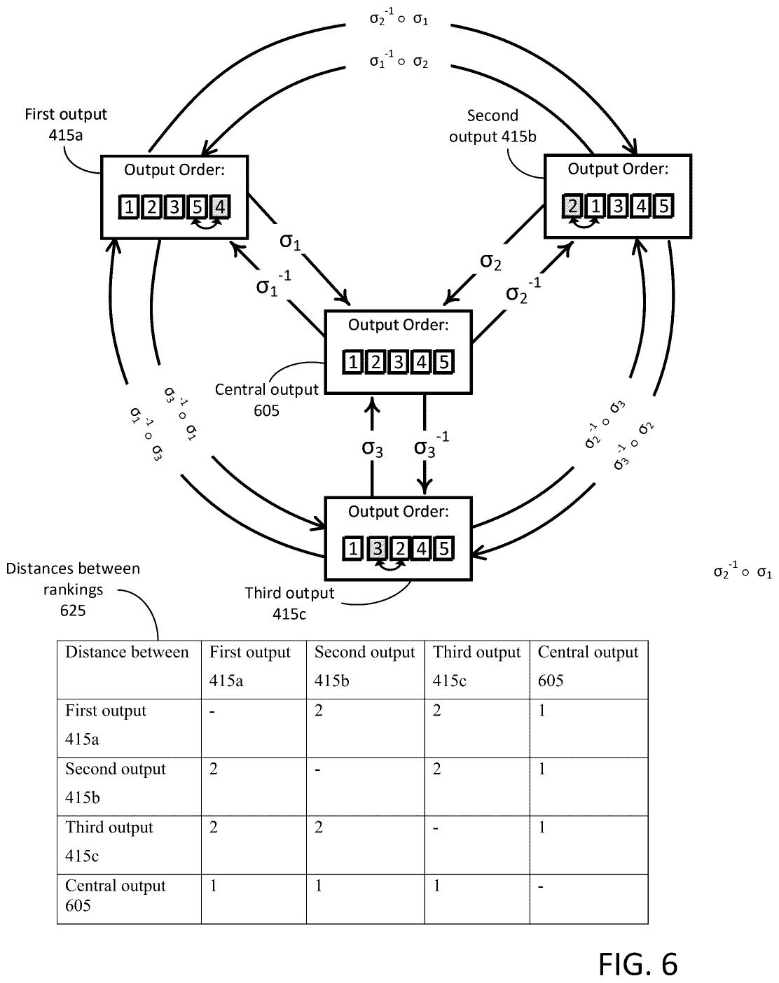

FIG. 6 shows example LLM outputs of a plurality of LLM inputs having permutations of an LLM input and inversion operations used to move between the LLM outputs. The input may comprise a list of integers and instructions to sort the list. The likely understanding of an order for a series of integers, is the series ordered in ascending order from the lowest to the highest. A list of integers may be sorted as (1, 2, 3, 4, 5), for example, if the list integers is the first 5 integers. Moreover, a final (e.g., central, likely, etc.) output 605 may be determined, for example, based on an aggregation of the plurality of output results, for example, by determining a distance (e.g., Kendall tau distance) between the plurality of outputs 415. The n-rankings for sorting a list of integers may comprise permutations that shift members of the list one or more positions in the list, for example, modulo the length of the list. Other permutations may comprise a swap, for example, where two members of the list are swapped, and shifts (e.g., a cycle) comprising three or more members. Other permutations may comprise the permutations described above.

A number of output orderings for a sort of integers may be determined, for example, by determining the number of permutations between the different output lists. The distance between each of the first output 415a, the second output 415b, the third output 415c, and a final (e.g., central, likely, etc.) output 605 may be determined to be one, for example, based on swapping only one pair of numbers (e.g., σ₁, σ₂, or σ₃) between the first output 415a, the second output 415b, or the third output 415c and the final (e.g., central, likely, etc.) output 605. The number of permutations between each of the first output 415a, the second output 415b, and the third output 415c and each other may be determined to be two steps, for example, based on swapping two pairs of numbers between any of the sets (e.g., σ₂⁻¹ o σ₁, σ₃⁻¹ o σ₂, σ₁⁻¹ o σ₃, or their inverses). The distances between rankings 625 may be determined and the outputs aggregated to determine the least number of discordant pairs between ranking (e.g., the lowest Kendall tau distance). The outputs with the lowest number of discordant pairs may be considered the most similar, for example, if using the Kendall tau correlation to determine similarity.

Generating a plurality of LLM input prompts by permuting an input list contained in an original input prompt and aggregating the resulting plurality of LLM outputs generated by the plurality of input prompts may be performed by a single device or a plurality of devices. A device comprising the LLM (e.g., a content server 106, an LLM server 122, etc.), for example, may generate multiple input prompts comprising multiple permuted lists from an original input prompt to the LLM and aggregate the resulting outputs to derive a final (e.g., central, likely, etc.) output as a response to the original input prompt. Alternatively, a device other than the LLM (e.g., a mobile device 125, a laptop computer 115, a personal computer 114, a wireless device 116, etc.) may receive an input prompt for the LLM and generate multiple input prompts to send to a device comprising the LLM and aggregate the received output responses that may be generated by the LLM based on the multiple input prompts.

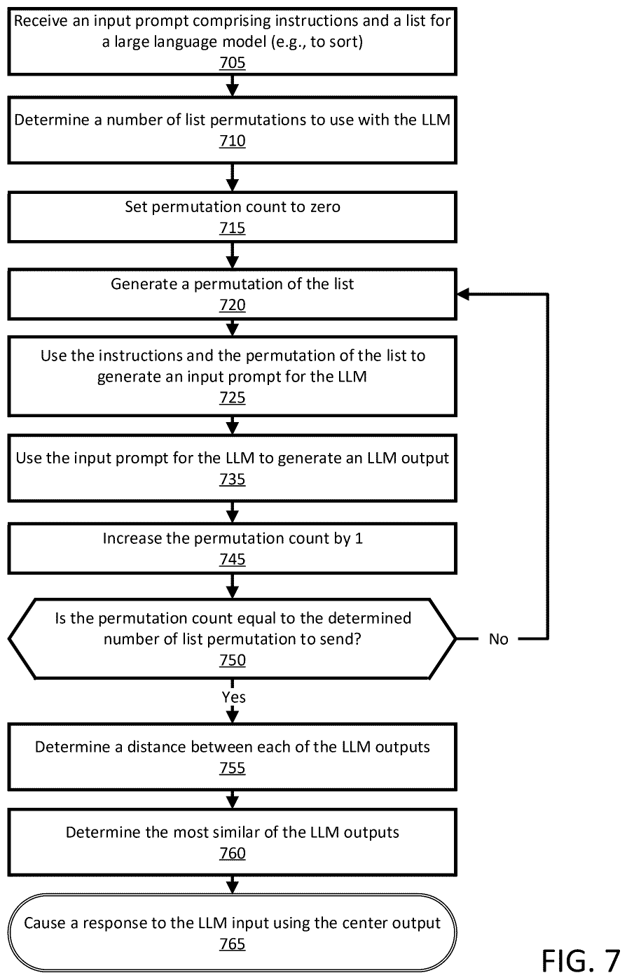

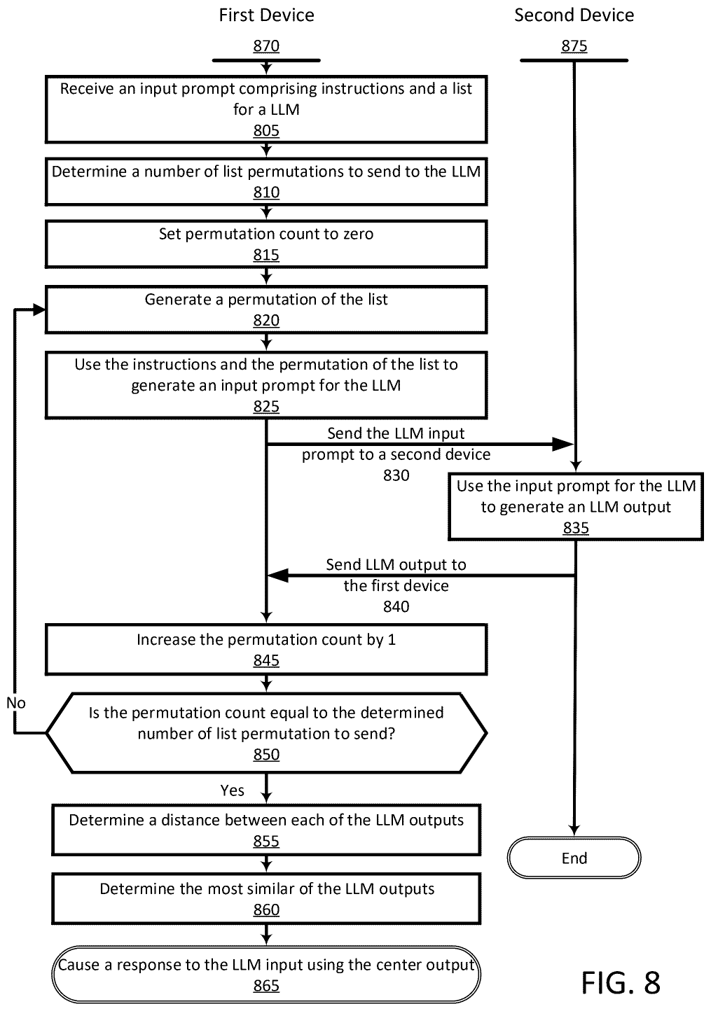

FIGS. 7 and 8 are example flow charts showing example methods for determining a final (e.g., central, likely, etc.) LLM output. FIG. 7A shows an example flow chart showing an example method for determining a final (e.g., central, likely, etc.) LLM output comprising a single device. The method of FIG. 7 may be implemented, for example, by a device (e.g., a LLM server 122) comprising the LLM receiving the input prompt for the LLM.

In step 705, a device may receive an original input prompt for an LLM. The original LLM prompt may comprise instructions (e.g., sort a list) and/or a list of items. The instructions and list may be parsed from the original input prompt. The list may comprise, for example, a list of math expressions to sort, a set of shuffled sentence to order, and/or a list of passages to order based on relevancy.

In step 710, a number of permutations of the list of items to use with the LLM may be determined. The number of permutations of the list may be defined. The number of permutations of the list may be determined. The number of permutations may, for example, be based on the number of elements of the list. The number of permutations may depend on the LLM used. A number of permutations may be, for example, five, but may be less or more depending on the LLM and/or other factors.

A counter may be used, for example, to track the number of permuted lists of items that have been generated and the LLM outputs that have been generated based on the LLM inputs comprising the permuted lists. In step 715, a permutation count may be set to zero. The permutation count, for example, may be used to determine both the number of permuted lists and the number of LLM outputs received.

In step 720, a permutation (e.g., a random permutation) of the list of items may be generated. A table of unique permuted lists may be determined, for example, based on the list of items, and for example, and each list selected (e.g., randomly) from the table. A table may provide the capability for more permuted lists and may provide for the capability to characterize a final (e.g., central, likely, etc.) output dynamically and determine if additional permuted lists are to be used to generate additional LLM outputs from additional LLM inputs. Alternatively, a set, having a length equal to the number of permutations, of permuted lists may be determined based on the list of items. The set may comprise fewer permuted lists (e.g., the number determined in step 710) and, as a result, may be quicker, but the final (e.g., central, likely, etc.) output may not be capable of being dynamically analyzed limiting the ability to adjust to final (e.g., central, likely, etc.) outputs that may not be converging to a shortest distance. A permuted list may be determined, for example, randomly as an LLM input prompt is being generated. This final method may be the quickest, but may have a reduced capability of adjusting a number of input prompts dynamically. Moreover, it may be determined that prompt order bias is based on regions (e.g., ranges) where certain regions of the input list are utilized less productively, so having a table of permuted lists may be beneficial in controlling the regions of a list that experience any LLM bias.

In step 725, the LLM input prompt comprising the instructions received in step 705 and the permuted list of items generated in step 720 may be appended together to generate a permuted LLM input that may be used by the LLM to generate an LLM output.

LLM outputs based on the permuted LLM inputs may be generated. In step 735, the permuted LLM input prompt comprising the instructions received in step 705 and the permuted list of items may be used to generate an LLM output.

In step 745, the permutation count may be increased. The permutation count may be increased by one, for example, to reflect that a permuted list was used to generate an LLM output response based on the permuted LLM input generated in step 725.

In step 750, the permutation count may be compared to the number of permuted lists to use for an LLM input prompt. The permutation count may be compared to the permuted lists to use, for example, to determine if additional permuted lists and additional permuted LLM input prompts are to be generated and used to generate additional LLM outputs.

The resulting plurality of LLM outputs may be aggregated to determine a center LLM output, for example, once the permutation count equals the number of list permutations to send and the permuted LLM inputs comprising a permuted list have been used to generate LLM outputs. In step 755, a distance between each of the LLM outputs may be determined. The distance between each of the LLM outputs may be determined, for example, using the Kendall tau distance formula as described herein, for example, with reference to equation 5.

In step 760, a similarity between each of the LLM outputs may be determined. The similarity of each LLM output may be determined, for example, using the Kendall tau correlation as described herein, for example, with reference to equation 6.

In step 765, a response to the original LLM input using the center output may be caused. A device may send the final (e.g., central, likely, etc.) output to a second device. A LLM server 122 may send the final (e.g., central, likely, etc.) output to a second device, for example, as a response to the original LLM input prompt received in step 705.

FIG. 8 shows an example flow chart showing an example method for determining a final (e.g., central, likely, etc.) LLM output comprising a first device 870 (e.g., a mobile device 125, a laptop computer 115, a personal computer 114, a wireless device 116, etc.) and a second device 875 (e.g., a content server 106, an LLM server 122, etc.). The two devices may comprise, for example, a first device 870 that is a mobile device 125 and a second device that is a LLM server 122, where the mobile device 125 is seeking an output from an LLM that LLM server 122 comprises based on input at the mobile device 125. The first device 870 may send multiple LLM inputs, for example, comprising the same instructions but with permuted lists, to the second device 875 and receive the associated LLM outputs from the second device 875 (e.g., a content server 106, an LLM server 122, etc.) based on the multiple LLM inputs. The first device 870 may aggregate the associated LLM outputs, for example, based upon receiving a certain number of LLM outputs, to determine a final (e.g., central, likely, etc.) LLM output associated with the original LLM input.

In step 805, of FIG. 8, the first device 870 may receive an original input prompt for an LLM. Step 805 may be comprised by step 705 of FIG. 7. The original input prompt may be input by a user of the first device (e.g., a mobile device 125, a laptop computer 1115, a personal computer 114, a wireless device 116, etc.).

In step 810, a number of permutations of the list of items to send may be determined. Step 810 may be comprised by step 710 of FIG. 7.

In step 815, a permutation count may be set to zero. Step 815 may be comprised by step 715 of FIG. 7.

In step 820, the first device may generate a permutation (e.g., a random permutation) of the list of items. Step 820 may be comprised by step 720 of FIG. 7.

In step 825, the LLM input prompt comprising the instructions received in step 805 and the permuted list of items generated in step 820 may be appended together to generate a permuted LLM input that may be used by the LLM to generate an LLM output.

In step 830, the permuted LLM input may be sent by the first device 870 to a second device 875, for example, if the second device 875 is a device comprising the LLM. The second device 875 may be, for example, an LLM server 122 comprising the LLM model.

In step 835, the permuted LLM input prompt comprising the instructions received in step 805 and the permuted list of items may be used to generate an LLM output. Step 835 may be comprised by step 735 of FIG. 7.

In Step 840, the LLM output, based on the permuted LLM input prompt, may be sent from the second device 875 to the first device 870. The LLM output may be sent to the first device 870, for example, if the second device 875 comprises the LLM.

In step 845, the permutation count may be increased, for example, by one to reflect that a permuted list was used to generate an LLM output response based on the permuted LLM input generated in step 825.

In step 850, the permutation count may be compared to the number of permuted lists to use for an LLM input prompt, for example, to determine if additional input LLM prompts are to be sent, by the first device 870, to the second device 875. The permutation count may be compared to the number of permuted lists to send generated in step 810, for example, to determine if additional permuted lists and additional permuted LLM input prompts are to be generated and used to generate additional LLM outputs.

The resulting plurality of LLM outputs may be aggregated to determine a center LLM output. In step 855, a distance between each of the LLM outputs may be determined. The distance between each of the LLM outputs may be determined, for example, using the Kendall tau distance formula as described herein, for example, with reference to equation 5.

In step 860, a similarity between each of the LLM outputs may be determined. The similarity of each LLM output may be determined, for example, using the Kendall tau correlation as described herein, for example, with reference to equation 6.

In step 865, a response to the original LLM input using the center output may be caused. A device may send the final (e.g., central, likely, etc.) output to a third device, for example, as a response to the original LLM input prompt. The final (e.g., central, likely, etc.) output may be used by the first device 870, for example, to generate a chatbot response to input generated by a user of the first device 870.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a device, a large language model (LLM) input prompt comprising a list of items in a first order;
generating a plurality of the list of items in different orders;
generating a plurality of LLM outputs from a plurality LLM inputs comprising one of the plurality of the list of items;
determining a final LLM output based on aggregating the plurality of LLM outputs; and
causing a response to the original LLM input using the final LLM.

2. The method of claim 1, further comprising sending the final LLM output to a second device.

3. The method of claim 1, wherein the LLM input prompt further comprises instructions; and
wherein the plurality of the LLM inputs further comprise the instructions.

4. The method of claim 1, wherein aggregating the plurality of LLM outputs comprises determining a Kendall tau distance between each of the plurality of LLM outputs; and the final LLM output is determined based on the Kendall tau distance.

5. The method of claim 1, wherein determining the final LLM output further comprises determining a similarity between each of the plurality of LLM outputs.

6. The method of claim 1, wherein the differing orders of the plurality of the list of items are determined randomly.

7. The method of claim 1, wherein aggregating the plurality of LLM outputs comprises determining a number of swaps between the plurality of LLM outputs; and wherein determining the final LLM output is based on the number of swaps.

8. The method of claim 1, wherein the device is a server.

9. A method comprising:
receiving, by a first device, an original large language model (LLM) input comprising instructions and a list of items having a first order;
generating a plurality of the list of items reordered differently;
generating a plurality of LLM inputs each comprising the instructions and one of the plurality of the list of items;
generating a final LLM output by aggregating a plurality of LLM outputs from the plurality of LLM inputs; and
sending, to a second device, the final LLM output.

10. The method of claim 9, wherein the instructions are to sort the list.

11. The method of claim 9, wherein aggregating the plurality of LLM outputs comprises determining a distance between each of the plurality of LLM outputs.

12. The method of claim 9, wherein determining the final LLM output of the plurality of LLM outputs comprises determining a similarity between each of the plurality of LLM outputs.

13. The method of claim 9, wherein, for each of the plurality of the list of items, the order of the list of items is determined randomly.

14. The method of claim 9, wherein a number of the plurality of inputs is based on the number of items in the list.

15. The method of claim 9, wherein the first device is a server and the second device is mobile device or a server.

16. A method comprising:
receiving, by a first device, a first large language model (LLM) input comprising a list in an original order;
generating a plurality of lists each comprising the list in random different orders;
sending, to a second device, a plurality of LLM inputs each comprising one of the plurality of lists;
receiving a plurality of LLM outputs based on the plurality of LLM inputs;
generating a final LLM output based on an aggregation of the plurality of LLM outputs; and
causing a response to the first LLM input using the final LLM.

17. The method of claim 16, further comprising sending the final LLM output to a third device.

18. The method of claim 16, further comprising determining a similarity between each of the plurality of LLM outputs; and wherein the aggregation of the plurality of LLM outputs is based on the similarity between the LLM outputs.

19. The method of claim 16, wherein generating the final LLM output comprises determining a distance between each of the plurality of LLM outputs, wherein the distance is determined based on the Kendall tau distance; and wherein the aggregation of the plurality of LLM outputs is based on the distances.

20. The method of claim 16, wherein the first device comprises a wireless device and the second device comprises a server.
